(19) United States
(12) Patent Application Publication
(10) Pub. No.: US 2010/0151403 A1
(43) Pub. Date: Jun. 17, 2010

(54) Bracket with improved arch wire slot liner

(76) Inventors: Lee H. Tuneberg, Sheboygan, WI (US); Bradley J. Brasser, Oostburg, WI (US)

Correspondence Address: Philip G. Meyers;Philip G. Meyers Law Office, Suite 300, 1009 Long Prairie Road, Flower Mound, TX, 75022, US

(21) Appl. No.: 12/316,439

(22) Filed: Dec. 12, 2008

(51) Int. Cl. A61C 7/28

(52) U.S. Cl. 433/10; 433/8

(57) ABSTRACT

A ceramic orthodontic bracket assembly for attaching an arch wire to a tooth of the invention includes a bracket body made of a first transparent or translucent ceramic which consists essentially of a monocrystalline alumina. The bracket body has a mesial-distal channel formed therein, and a generally rectangular liner made of a second transparent or translucent ceramic is disposed in the channel. The liner has occlusal and gingival side walls forming an archwire slot therebetween. Means such as brazing or adhesive are provided for bonding the liner in the channel in which it is configured to closely fit.

### FIELD OF THE INVENTION

The invention relates to brackets used in orthodontic treatment, more specifically to an orthodontic bracket having a clip or shutter for releasably retaining an arch wire in an arch wire slot of the bracket.

### BACKGROUND OF THE INVENTION

Self ligating brackets have been developed wherein each bracket has a clip or latch mounted thereon for retaining an arch wire in the arch wire slot. Christoff et al., U.S. Pat. No. 6,071,119, describes one such self ligating bracket and contains an extended discussion of different types of known self ligating bracket systems in its background section. Voudouris U.S. Pat. Nos. 5,908,293, 5,913,680, 5,813,852, 5,803,728, 5,692,898, and 5,595,484, among others, illustrate that a wide variety of self-ligating bracket structures have been proposed. In some of these designs, the shutter or clip is U-shaped and slides sideways (in an occlusal-gingival direction) from an open position to a closed position and back. As shown in Voudouris U.S. Pat. No. 5,630,715 FIGS. 31-34, the U-shaped shutter has a closure tab that slides over and covers the arch wire slot and a guide bar portion that slides into an opening in the bracket base and is positioned directly over the mounting pad. In recent years it has further been proposed to line the arch wire slot of the bracket with an insert or liner. Orikasa et al. U.S. Pat. No. 5,595,484 describes a plastic bracket body and a metal reinforcement member partly embedded in the bracket body. The bracket body includes a slot extending substantially along a mesial-distal axis of the bracket body for receiving an arch wire. The reinforcement member includes a holding notch having a width that is smaller than that of the slot of the bracket body. The holding notch is positioned inside the slot and spaced-apart from the slot surfaces to form an arch wire holding mechanism for engaging the arch wire and to substantially avoid contact between the arch wire and the surfaces of the slot.

Relatively little attention has been paid to the materials from which the liner and bracket combination is made. Orikasa et al. '484 mentions that the bracket body comprises a non-metallic material listing plastic, a transparent material, polycarbonate plastic, acrylic resin, and glass filled plastic material. Orthodontic brackets have also been made of translucent ceramic material such as polycrystalline aluminum oxide as described in U.S. Pat. No. 4,954,080. Ceramic is a relatively hard material in comparison to plastic. In Reed et al . U.S. Pat. No. 5,358,402, a ceramic orthodontic bracket comprises a ceramic body having an elongated channel, the bracket having a liner received in the channel and having an archwire slot, the liner being made of a material having a Knoop hardness that is less than the Knoop hardness of the ceramic body, the liner being brazed to the ceramic body. The apparent intent is that the Knoop hardness of the liner be similar to the Knoop hardness of the archwire in order to reduce the likelihood of galling or abrasive wear of the archwire. According to Reed et al., the liner also serves to dissipate localized areas of relatively high stress concentrations that might otherwise be imposed by the archwire. The described liner is made of a 0.002 in. (0.05 mm) thick sheet of no. 301 stainless steel, although a gold, titanium or palladium foil sheet may also be utilized. Liners made of these materials are, however, unsightly especially when present on a polycrystalline alumina bracket. See also Moschik U.S. Pat. No. 6,264,469 describing a base body made from plastic, the plastic being a highly cross-linked polyurethane made by addition polymerization.

The present invention addresses the need for an improved combination of materials for the bracket and liner contrary to the teachings of the foregoing patents in the field.

### SUMMARY OF THE INVENTION

A ceramic orthodontic bracket assembly for attaching an arch wire to a tooth of the invention includes a bracket body made of a first transparent or translucent ceramic which consists essentially of a monocrystalline alumina having a base portion securable to a mounting pad secured to a tooth surface and having occlusal and gingival tie wings, the bracket body having a mesial-distal channel formed therein, and a generally rectangular liner made of a second transparent or translucent ceramic, which liner is disposed in the channel on the bracket body. The liner has occlusal and gingival side walls forming an archwire slot therebetween. Suitable means such as brazing or adhesive are provided for bonding the liner in the channel in which it is configured to closely fit. The second ceramic preferably has a hardness greater than or substantially equal to the first ceramic. The liner and bracket combination according to the invention provides both improved physical properties including hardness, and improved cosmetic appearance.

According to a further aspect of the invention, one of either the gingival and occlusal side walls of the liner that forms the archwire slot has a groove or grooves formed therein for retaining the locking end portion of the clip. These and other aspects of the invention are described further in the detailed description that follows.

### BRIEF DESCRIPTION OF THE DRAWINGS

In the accompanying drawings, wherein like numerals represent like elements:

FIG. 1 is a top view of a bracket and liner assembly according to the invention;

FIG. 2 is an occlusal perspective view of the bracket and liner shown in FIG. 1;

FIG. 3 is a side view of the bracket and liner shown in FIG. 1; and

FIG. 4 is an occlusal (rear) view of the bracket and liner shown in FIG. 1.

### DETAILED DESCRIPTION

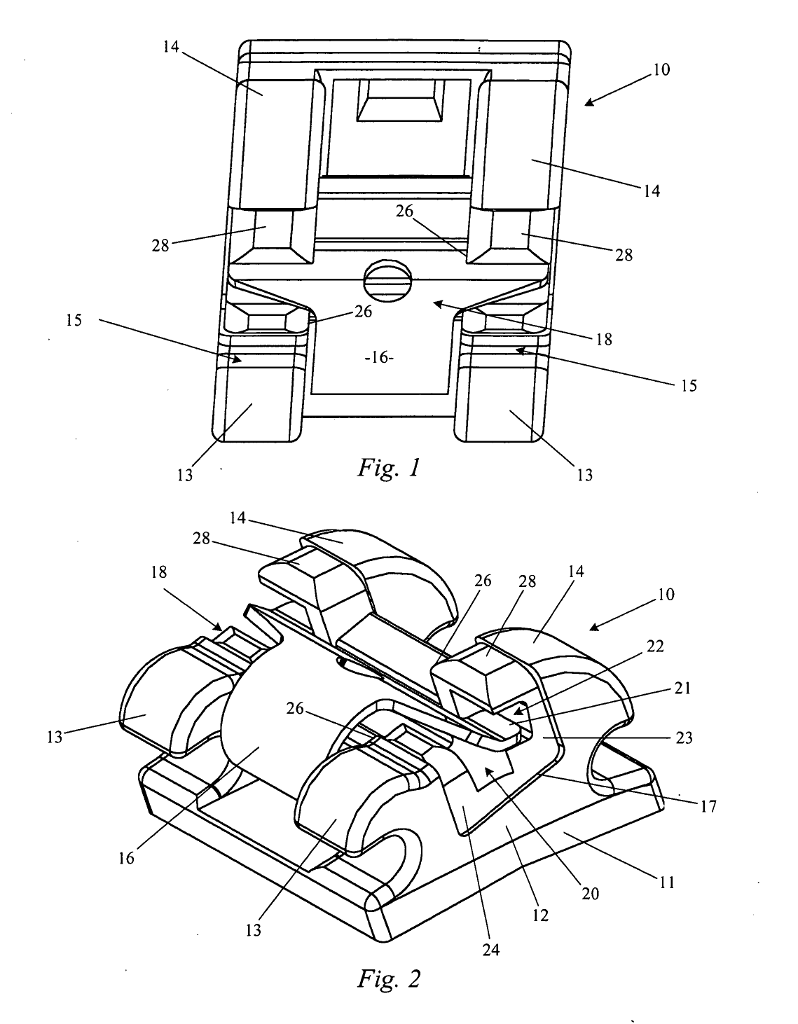

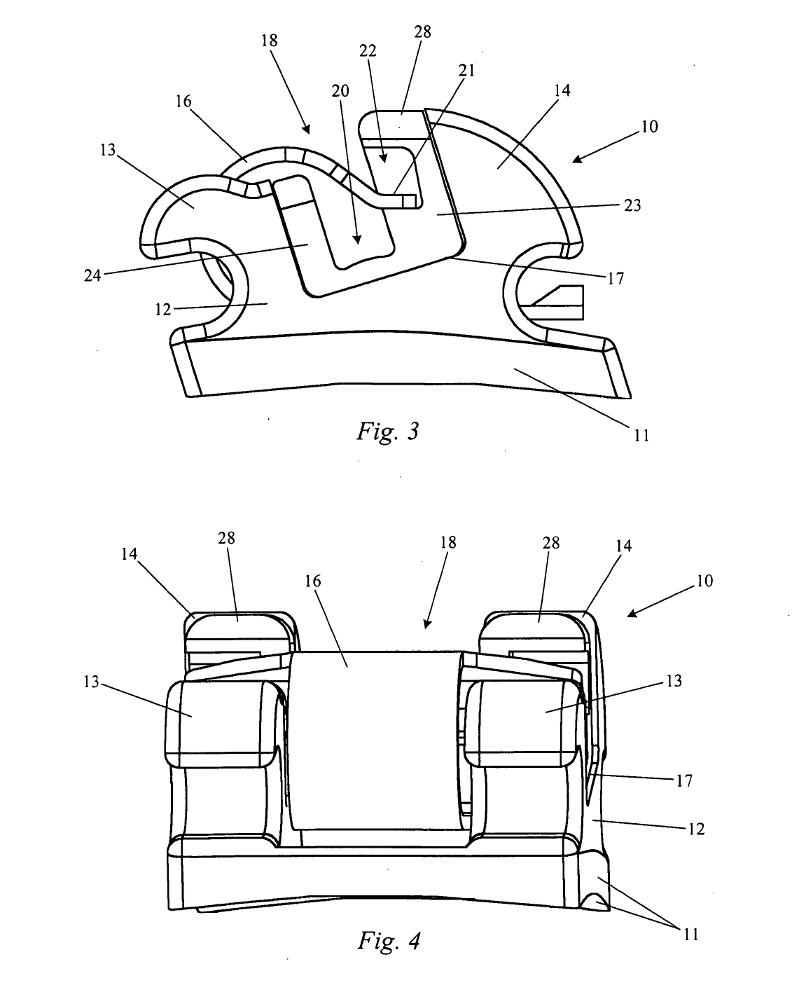

Referring to FIGS. 1-4, an orthodontic bracket assembly 10 for attaching an arch wire to a tooth includes a mounting pad 1 1, a bracket body 12 with occlusal and gingival tie wings 13, 14 and a generally U shaped, slidable locking clip or shutter 16. The bracket body 12 has surfaces defining a slot or channel 17 extending substantially along a mesial-distal axis of the bracket body 12 for receiving a generally rectangular insert or liner 18. Liner 18 in turn has an outwardly facing channel therein that defines the arch wire slot 20. The outer surface of liner 18 is secured to the adjoining inner surface of channel 17 by means of a suitable ceramic adhesive or brazing material such as a silver/copper/titanium braze paste. Commercially available alloys for this purpose include HF 410 HF 420 braze paste.

It is typical of brackets that use a U-shaped repositionable clip or shutter that one end of the shutter engage recesses beneath the gingival tie wing(s) and the other end reaches around and engages the underside of the occlusal tie wings, or extends through an aperture in the base of the bracket to form a “tail” portion that is retained by press-fit engagement with protrusions or the like. The bracket of the present invention in this example is of the latter type, but either could be used. However, the ends (locking tabs) 21 of the clip 16 that normally fit under the gingival tie wings 14 instead fit into a pair of spaced openings 22 in a side wall of the liner 18. This eliminates the need to provide such features on the bracket body; they can be pre-formed on the liner 18.

As shown in FIGS. 1-2, liner 18 has a gingival side wall 23 and a occlusal side wall 24 which form the arch wire slot 20 between them. Gingival side wall 23 is thicker (twice as thick or more) than occlusal side wall 24 to better form openings 22 therein. Central cutaways 26 in the external ends of walls 23, 24 are formed in opposing positions between a pair of protrusions 28 in which openings 22 are formed. Depending on the size of the arch wire used, the clip 16 can be of the passive or active type. As is known in the art, clip 16 can be withdrawn to an open position as shown in FIG. 6 wherein tips 21 are temporarily set in rounded outer depressions 15 on tie wings 13.

Orthodontic brackets have also been made of translucent ceramic material such as polycrystalline aluminum oxide as is described in U.S. Pat. No. 4,954,080. For methods of making polycrystalline alumina, see, for example, Castro, et al., U.S. Pat. No. 6,648,638, incorporated by reference herein. Ceramics such as alumina are hard in comparison to plastic and most metals, and do not exhibit creep deformation in areas adjacent the archwire slot when subjected to forces of the archwire. However, application of an undue force by the arch wire may fracture the bracket, possibly because of localized areas of relatively high stress concentrations.

Monocrystalline alumina upon final heat treatment is clear as glass, but can be doped to obtain colors. Polycrystalline alumina can vary from nearly transparent to translucent (cloudy). The multi-grain structure of polycrystalline alumina gives it poorer fracture toughness than monocrystalline alumina. In polycrystalline alumina increasing grain size increases its transparency but lowers its fracture toughness. Increasing the transparency of the polycrystalline alumina can be done using dopants known in the art. The grain sizes of the second ceramic according to the invention forming the liner will generally be about 1 micron or less, preferably about 0.8 micron.

The main body 12 of the bracket of the present invention is preferably made entirely of a monocrystalline alumina with a Vickers hardness (HV 1) of 2100, whereas polycrystalline alumina usable as the liner has a Vickers hardness (HV 1) of 2200. Zirconia toughened alumina can be used to make the liner as well, but its reported hardness of 2050 is slightly less than or approximately the same as that of monocrystalline alumina. A partially zirconia toughened alumina may provide best results. Other ceramics may also be useful for the liner, such as partially stabilized zirconia (PSZ). Takagi et al. U.S. Pat. No. 5,338,713 describes a process for making a PSZ, and is incorporated by reference herein.

Both liner and body should be made of a transparent or translucent ceramic having a hardness of at least about 1500 HV 1, but use of a polycrystalline alumina having a hardness greater than or equal to 2200 HV 1 is preferred for the liner. In an experiment with using a Vickers diamond pyramid indenter, a monocrystalline alumina for use as the bracket body gave an average indentation depth of 13.2, whereas the same test run on a polycrystalline liner material of the invention gave an average indentation of 12.6 when measured in two directions. Hardness for the polycrystalline material was greater than that of the monocrystalline material overall, but was less in a few individual measurements taken in certain orientations. For purposes of resisting forces exerted by the arch wire on the liner, it is important that both bracket body and liner have sufficient hardness to be durable, and this can be attained using mono- and polycrystalline materials as discussed above. The second ceramic according to the invention could comprise combination materials such as zirconia-alumina as mentioned above, and doped aluminas.

Preferably both liner and bracket are transparent or nearly so such that the assembly has a jewel-like appearance that is aesthetically pleasing, in contrast with the dull appearance of metal liners' when placed on a crystalline alumina bracket as background. Since both pieces are alumina, it is useful to bond the liner in channel 17 using brazing or an adhesive. Brazing is less preferable because the heating of the brazing process can damage the bracket assembly. Accordingly it is most preferred to secure liner 18 using a well known dental bis-GMA-based adhesive.

It will be understood that the foregoing description is of preferred exemplary embodiments of the invention, and that the invention is not limited to the specific forms described and illustrated. Modifications may be made in without departing from the spirit of the invention as expressed in the appended claims.

1. An orthodontic bracket assembly for attaching an arch wire to a tooth, a bracket body made of a first transparent or translucent ceramic which consists essentially of a monocrystalline alumina having a base portion securable to a mounting pad secured to a tooth surface and having occlusal and gingival tie wings, the bracket body having a mesial-distal channel formed therein;
a generally rectangular liner made of a second transparent or translucent ceramic, which liner is disposed in the channel on the bracket body, the liner having occlusal and gingival side walls forming an archwire slot therebetween; and
means for bonding the liner in the channel.

2. The bracket of claim 1, wherein the second ceramic has a hardness greater than or substantially equal to that of the first ceramic, and he first and second ceramics each have a hardness of at least 1500 HV1.

3. The bracket of claim 1, wherein the second ceramic is selected from polycrystalline alumina, partially stabilized zirconia, and zirconia toughened alumina, the first and second ceramics each having a hardness of at least 1500 HV1.

4. The bracket assembly of claim 1 wherein the means for bonding the liner in the channel comprises either a dental adhesive or a metal alloy braze effective for bonding ceramic surfaces.

5. The bracket assembly of claim 1 wherein the gingival side wall has a groove for retaining the gingival locking end portion of the clip therein.

6. The bracket assembly of claim 1 wherein the second ceramic consists essentially of a polycrystalline alumina having grain sizes of 1 micron or less.

7. An orthodontic bracket for attaching an arch wire to a tooth, comprising:
a mounting pad,
a bracket body having a base portion secured to the mounting pad and occlusal and gingival tie wings, the bracket body having a mesial-distal channel formed therein;
a generally U shaped, slidable locking clip mounted on the bracket having a gingival or occlusal locking end portion;
a liner disposed in the channel on the bracket body, the liner having occlusal and gingival side walls forming an archwire slot therebetween, and one of the gingival and occlusal walls having a groove for retaining the gingival locking end portion of the clip therein; and
means for bonding the liner in the channel.

8. The orthodontic bracket of claim 7, wherein the bracket body consists essentially of monocrystalline alumina and the liner consists essentially of polycrystalline alumina having grain sizes of 1 micron or less.

9. The orthodontic bracket of claim 7, wherein the bracket body consists essentially of monocrystalline alumina and the liner consists essentially of partially stabilized zirconia.
